(19) United States
(12) Patent Application Publication
(10) Pub. No.: US 2026/0021960 A1
(43) Pub. Date: Jan. 22, 2026

(54) COMBINED DOG WASTE BAG DISPENSER AND CONTAINER

(71) Applicant: Aren John Edye, Leichhardt (AU)

(72) Inventor: Aren John Edye, Leichhardt (AU)

(21) Appl. No.: 19/277,297

(22) Filed: Jul. 22, 2025

(30) Foreign Application Priority Data
Jul. 22, 2024 (AU) 2024902274

(51) Int. Cl. B65F 1/14; B65D 83/08

(52) U.S. Cl. CPC B65F 1/1426; B65D 83/0888; B65F 2240/136

(57) ABSTRACT

A combined dog waste bag dispenser and container comprising a plurality of detachable portions including an upper portion, a middle portion, and a lower portion. The plurality of portions is detachably removable from adjacent portions. A lower portion comprises a cavity for storing unused waste bags, and an aperture for dispensing said bags. A middle portion contains a cavity for storing used waste bags, whereas the upper portion is detachably removable from the middle portion to access the cavity.

### FIELD OF THE INVENTION

The present invention generally relates to an apparatus for management of animal excrement, in particular, to an apparatus for dispensing dog waste bags and their subsequent storage.

### BACKGROUND TO THE INVENTION

As pet ownership increases globally, so does the need for responsible pet waste management. In particular, to ensure that public spaces remain clean and hygienic for public health. Existing solutions for pet waste collection often lack convenience, accessibility, and proper disposal methods, leading to improper waste management and environmental pollution.

Traditional dog waste bag dispensers are typically standalone units that require separate disposal bins. This separation can be inconvenient for pet owners, who must locate and access multiple facilities, or apparatus, to manage pet waste responsibly.

Typically, pet owners may be required to carry waste bags until they arrive home to dispose of the filled bags. A lack of an integrated apparatus for both the dispensing and disposal functions may therefore lead to increased littering. For example, pet owners may take multiple bags at once or fail to dispose of used bags correctly, exacerbating the problem of waste accumulation in public areas.

The present invention aims to address these challenges by providing an integrated solution that combines the dispensing of dog waste bags with a convenient and hygienic storage system for the used bags. The innovative design seeks to enhance user experience, promote responsible pet waste management, and reduce environmental impact.

Is it therefore an object of the present invention to overcome or ameliorate a problem of the prior art, or at least provide the public with a useful alternative by providing an apparatus combining dispensing and storage functions in a single, streamlined unit.

### SUMMARY OF THE INVENTION

In an embodiment, the invention provides an apparatus for management of animal excreta, comprising: a plurality of portions, comprising a first upper portion, a middle portion, and a lower portion; wherein each of the plurality of portions may be removably affixed to an adjacent portion; the bottom portion comprising a first cavity adapted to store unused excreta storage bags, and an aperture adapted to dispense the bags; and the middle portion comprising a second cavity adapted to store used bags, wherein a bottom of the second cavity is sealed and a top of the second cavity is open.

In an embodiment, each of the plurality of portions comprise threads to engage with adjacent portions.

In an embodiment, the top portion comprises a handle to enable a user to easily engage or disengage the top portion its adjacent portion.

In an embodiment, the handle comprises two semicircular grooves.

In an embodiment, the apparatus is constructed from plastic.

In an embodiment, the apparatus is constructed from steel.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following detailed description which provides sufficient information for those skilled in the art to perform the invention. The detailed description is not to be regarded as limiting the scope of the preceding summary of the invention in any way. The detailed description will make reference to a number of drawings as follows.

FIG. 1 illustrates an exploded side view of the apparatus according to a preferred embodiment of the invention;

FIG. 2 illustrates a side view of the apparatus;

FIG. 3 illustrates a top view of the apparatus;

FIG. 4 illustrates a bottom view of the apparatus;

FIG. 5 illustrates a top perspective view of the apparatus; and

FIG. 6 illustrates a bottom perspective view of the apparatus with bottom cap removed.

### LIST OF COMPONENTS

The drawings refer to the following reference numerals:

| | | | |
|---|---|---|---|
| 10 | upper portion | 12 | internal thread |
| 14 | upper surface | 16 | handle |
| 20 | middle portion | 22 | upper thread |
| 24 | body | 26 | cavity |
| 28 | sealed bottom | 29 | open top |
| 30 | bottom portion | 32 | internal thread |
| 34 | aperture | 36 | cavity |
| 38 | bottom surface | 39 | open top |

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

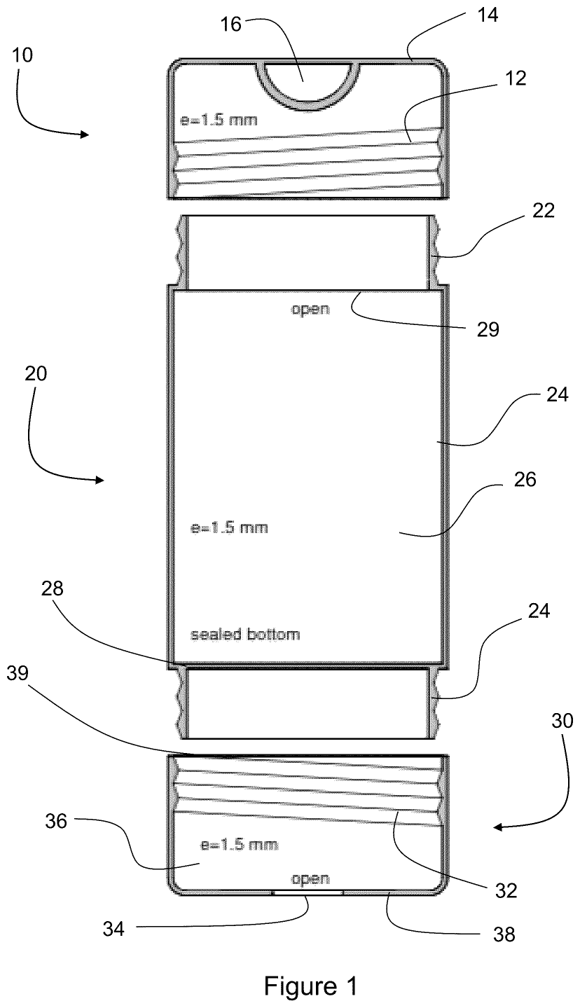

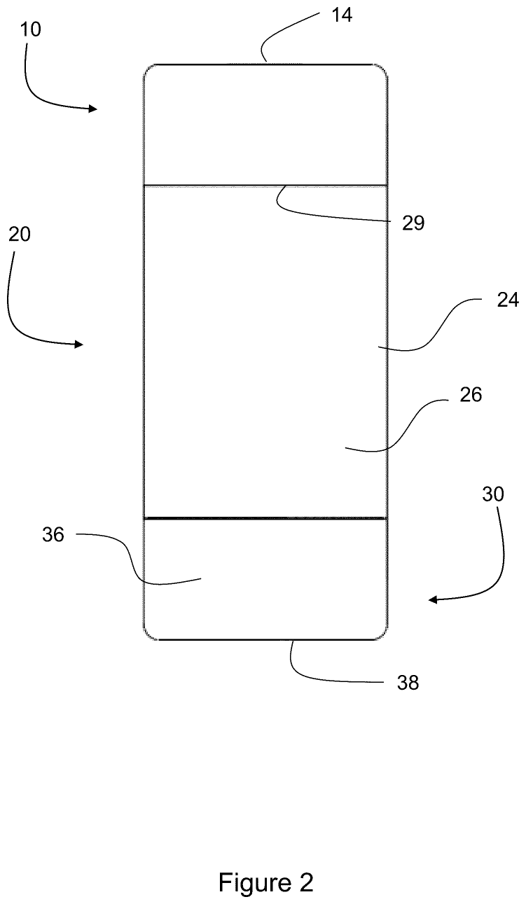

Referring now to FIG. 1, there is illustrated an exploded view of a substantially cylindrical apparatus for dispensing and storing dog waste bags according to a preferred embodiment of the invention. FIG. 2 illustrates the apparatus in a closed configuration. It is to be understood that the apparatus is not to be limited to having a cylindrical shape. One skilled in the art could construct the disclosed apparatus in different embodiments having different shapes such as but not limited to cuboid, pyramidal, ovoid, and the like.

The apparatus comprises a plurality of cylindrical portions, including upper portion 10, middle portion 20, and bottom portion 30, which may be detachably engaged with adjacent portions. Upper portion 10 is detachably engaged with middle portion 20, which in turn is detachably engaged with bottom portion 20. Upper portion 10 and bottom portion 30 detachably engage through cylindrical internal threads 12, 32, which engage with cylindrical external threads 22, 24 on opposite ends of middle portion 20.

Bottom portion 30 comprises an internal cavity 36 adapted to store waste collection bags (not pictured). An aperture 34 is situated about the centre of a bottom surface 38, for dispensing bags, enabling a user to retrieve individual waste bags from within cavity 36. In an embodiment, the apparatus may comprise a removable cover (not pictured) over aperture 34 to prevent unwanted ingress or egress of material into or out of cavity 36. An open top 39 of bottom portion 30 comprises internal thread 32 adapted to engage with bottom thread 24 of middle portion 20.

Middle portion 20 comprises a central body 24 with cavity 26 adapted to store filled waste bags (not pictured). A bottom 28 of cavity 26 is sealed to enable storage of the filled waste bags, separating the cavity 26 of middle portion 20 and cavity 36 of bottom portion 30. As such, the apparatus comprises a plurality of separate cavities, a first cavity adapted to store filled waste bags, and a second cavity adapted to store unused waste bags.

Cavity 26 comprises an open top 29 enabling a user to deposit stored waste bags through the provided opening. Upper thread 22 is located above open top 29, which is adapted to engage internal thread 12 of upper portion 10.

The user may access cavity 26 through open top 29 but engaging or disengaging upper portion 10 from middle portion 20. A handle 16 is provided on an upper surface 14 of upper portion 10 to enable the user to easily rotate, and thereby disengage them. The user may then deposit, or empty, filed waste bags into or out of the apparatus. After emptying cavity 26 of filled waste bags, the user may then clean cavity 26 with access from open top 29.

When middle portion 20 is engaged with upper portion 10 and bottom portion 30, there is provided an airtight cavity 26 of the middle portion preventing ingress or egress of material. Bottom cavity 36 is substantially enclosed except for aperture 34 enabling the user to retrieve unused waste bags.

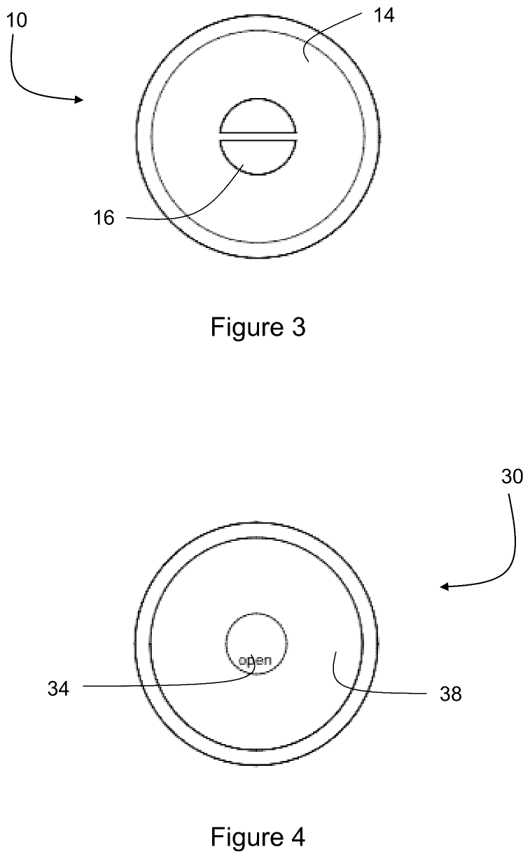

Referring now to FIG. 3, there is provided a top view of upper portion 10. In an embodiment, handle 16 may comprise two semicircular grooves that partially extend into upper surface 14 providing a grip for the user to engage or disengage upper portion 10 from middle portion 20. It is to be understood that the handle is not limited to such an arrangement, and any other arrangements as would be commonly understood by one skilled in the art may be used instead. In an embodiment, handle 16 may instead comprise raised surfaces, instead of recessed surfaces, for a user to grip onto and rotate the upper portion open.

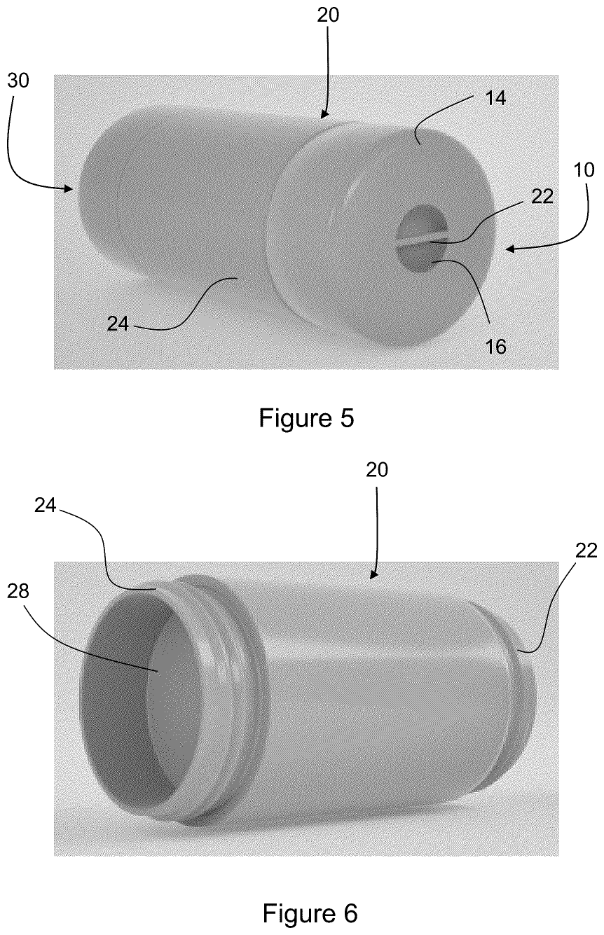

In the embodiment illustrated in FIGS. 5-6, the apparatus comprises a substantially cylindrical shape. It should be understood that the invention is not limited to such an embodiment, and any shape deemed aesthetically pleasing or functional to storage and disposal of animal waste bags may instead be used.

The apparatus may be constructed from, but not limited to any suitable material including rigid plastics such as polyethylene, polypropylene, or metals such as stainless steel, aluminium, and the like.

The reader will now appreciate the advantages of present invention which provides an apparatus with an integrated solution of dispensing and storage of animal waste bags.

Further advantages and improvements may very well be made to the present invention without deviating from its scope. Although the invention has been shown and described in what is conceived to be the most practical and preferred embodiment, it is recognised that departure may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. An apparatus for management of animal excreta, comprising:
a plurality of portions, comprising a first upper portion, a middle portion, and a lower portion;
wherein each of the plurality of portions may be removably affixed to an adjacent portion;
the lower portion comprising a first cavity adapted to store unused excreta storage bags, and an aperture adapted to dispense the bags; and
the middle portion comprising a second cavity adapted to store used bags, wherein a bottom of the second cavity is sealed and a top of the second cavity is open.

2. The apparatus of claim 1, wherein each of the plurality of portions comprise threads to engage with adjacent portions.

3. The apparatus of claim 1, wherein the top portion comprises a handle to enable a user to easily engage or disengage the top portion its adjacent portion.

4. The apparatus of claim 3, wherein the handle comprises two semicircular grooves.

5. The apparatus of claim 1, constructed from plastic.

6. The apparatus of claim 1, constructed from steel.
